(19) United States
(12) Patent Application Publication
(10) Pub. No.: US 2014/0337597 A1
(43) Pub. Date: Nov. 13, 2014

(54) COMPUTER, PROGRAM, AND MEMORY MANAGEMENT METHOD

(71) Applicants: Motoki Obata, Tokyo (JP); Yasushi Miyata, Tokyo (JP); Hiroyasu Nishiyama, Tokyo (JP)

(72) Inventors: Motoki Obata, Tokyo (JP); Yasushi Miyata, Tokyo (JP); Hiroyasu Nishiyama, Tokyo (JP)

(73) Assignee: HITACHI, LTD., Tokyo (JP)

(21) Appl. No.: 14/359,325

(22) PCT Filed: Mar. 2, 2012
(86) PCT No.: PCT/JP2012/001432

§ 371 Date: May 20, 2014

(51) Int. Cl. G06F 3/06

(52) U.S. Cl. CPC G06F 3/0647; G06F 3/0604; G06F 3/0683
USPC 711/165

(57) ABSTRACT

A computer capable of managing reference relationships between data executes access of first and second storage regions in which stored data can be altered and a third storage region in which stored data cannot be altered. The computer sets specification data in the first storage region for accessing data stored in the second and third storage regions, and shifts data having a reference relationship with the specification data from among the data stored in the third storage region to the second storage region. If the accessing occurs while the shifting is being carried out and the data has already been shifted to the second storage region, the reference information for the specification data is amended to the shifted location of the data, and all of the references to data in the third storage region that are referenced by the specification data are amended, thereby releasing the third storage region.

### TECHNICAL FIELD

The present invention relates to a computer, a program, and a memory management method, and in particular to a computer, a program, and a memory management method for managing data reference relationships.

### BACKGROUND ART

When a computer investigates reference relationships between data, a technique of stopping processing on data is generally used. Such investigation of data reference relationships is used in, for example, garbage collection which automatically manages whether data is necessary. In a garbage collector utilized in a Java (trademark) virtual machine, Stop-the-World scheme which completely stops operation of an application (hereafter referred to as “AP” or “program”) operating on the virtual machine is used in many cases.

Stopping the processing on data in the data reference relationship investigation in this way is conducted in order to prevent the reference relationships from being rewritten by data update or data deletion during the reference investigation. In many cases, reference relationships between data are investigated by using the scheme as in Java garbage collector. If the reference relationship investigation time increases, stop time in program execution (processing on data) also becomes long and a processing delay is caused.

A conceivable countermeasure against the problem is restriction of the investigation range. Non patent literature 1 discloses a technique of restricting a reference investigation region for a system having no data update such as a functional language. According to this technique, first, a memory region is divided into a region storing old generation data and a region storing new generation data on the basis of order of data creation. And the number of times of unnecessary data collection processing required to collect regions of a determinate quantity is reduced by preferentially executing collection processing of unnecessary regions intended for the region storing the new generation data. As a result, this technique can reduce the stopping time of processing such as an application.

Furthermore, non patent literature 2 discloses a technique of restricting a reference investigation region by increasing the number of generations in a generational garbage collection. At the time of collection processing of memory regions storing unnecessary data according to this technique, only one of regions obtained by dividing depending upon generations is made an object of reference source investigation. As compared with the case where all regions of old generation are made the object of collection processing, therefore, the quantity of data (regions) that become the reference source investigation object decreases. As a result, this technique can shorten the stopping time of processing on data in collection processing of unnecessary data regions of one time.

### CITATION LIST

### Non Patent Literature

Non Patent Literature 1: Todd A. Anderson, Optimization in a Private Nursery-based Garbage Collector, In Proceedings of the 2010 international symposium on Memory management, pp. 21-30, 2010
Non Patent Literature 2: Richard L. Hudson, Incremental collection of mature objects, In Proceedings of the International Workshop on Memory Management, pp. 388-403, 1992

### SUMMARY OF INVENTION

### Technical Problem

However, the technique disclosed in non patent literature 1 is premised on a functional language as described above. Therefore, the technique can be applied only under a special environment that an event in which data in new generation that did not exist when creating data in old generation is referenced by the data in old generation does not occur. The technique cannot be applied to a system using a language in which update other than deletion (by the way, here, deletion of data means bringing about a state in which the data is not referenced from specific data. In other words, a reference source is not newly added to data in new generation or old generation by deletion) occurs on data and an event in which data in old generation references data in new generation irrespective of the time of creation of data occurs. For investigating a reference source of data belonging to old generation, in such a system using a language in which data in old generation references data in new generation, it is necessary to make all regions including the new generation and old generation an investigation object, and it is not possible to restrict the reference investigation range to data belonging to new generation.

Furthermore, as disclosed in non patent literature 2, if a memory region storing data in old generation is divided according to generation and regions obtained by dividing the memory region in the order of data generation are allocated to a first generation, a second generation, . . . an N-th generation, reference source of data in the N-th generation can be restricted to data in the N-th generation and subsequent generations. Therefore, it can also be said that the reference investigation range can be restricted.

In non patent literature 2 as well, however, the investigation object of the reference relationships is not perfect in a case where update occurs in data in a generation before the N-th generation. Therefore, a problem that survived data is deleted carelessly (simultaneously with memory release processing) remains. In other words, it can be said that the technique is insufficient to be applied to a language in which update of data created once occurs.

In this way, the techniques disclosed in non patent literatures 1 and 2 do not become a fundamental solution for shortening the time for reference investigation because of a point that they cannot be applied to a system other than a system in which update does not occur on data stored earlier and a point that reference investigation itself of each generation must be conducted periodically.

### Solution to Problem

In order to solve the problem, for example, an aspect of the present invention is a computer including first and second storage regions that make it possible to change data retained therein, a third storage region that makes it impossible to change data retained therein, and a control unit that executes access to data retained in the second and third storage regions in response to a request from a program, wherein the control unit sets specific data for accessing data retained in the second and third storage regions, in the first storage region, the control unit causes the specific data to include reference information to data retained in the third storage region, in a case where while executing processing of moving data having a reference relationship with the specific data among data retained in the third storage region that is a release object into the second storage region, access to data retained in the third storage region via specific data occurs from the program, the control unit determines whether data that is an access object is already moved into the second storage region, in a case where data that is the access object is already moved into the second storage region, the control unit corrects reference information contained in the specific data to data of a movement destination, accesses the data that is the access object, and corrects all references from specific data having a reference relationship with data retained in the third storage region, and after the control unit corrects all of the references, the control unit releases the third storage region.

### Advantageous Effects of Invention

According to one aspect of the present invention, it is possible to shorten the stopping time of a program (such as, for example, an application) caused by release of a data storage region.

### BRIEF DESCRIPTION OF DRAWINGS

FIG. 1 is a block diagram showing a configuration of an embodiment to which the present invention is applied.

FIG. 2A is a schematic diagram showing an example of a closable region data creation API.

FIG. 2B is a schematic diagram showing an example of a closable region data creation API.

FIG. 3 is a schematic diagram showing storage regions and examples of data reference relationships in the present embodiment.

FIG. 4 is a flow diagram showing an example of release determination•data movement processing in the present embodiment.

FIG. 5 is a flow diagram showing an example of reference destination correction processing in the present embodiment.

FIG. 6 is a flow diagram showing an example of closed region release processing in the present embodiment.

FIG. 7 is a time flow showing relationships among program execution, release determination•data movement processing, reference destination correction processing, and closed region release processing in time series.

FIG. 8A is a schematic diagram showing storage regions and examples of data reference relationships before execution of release determination•data movement processing in the present embodiment.

FIG. 8B is a schematic diagram showing storage regions and examples of data reference relationships immediately before execution of closed region release processing in the present embodiment.

### DESCRIPTION OF EMBODIMENTS

Hereafter, an embodiment to which the present invention is applied will be described with reference to the drawings. By the way, in the present embodiment, an example in which the present invention is applied to a computer system premised on a Java virtual machine will be described. However, the present invention is not restricted to this, but the present invention is also effective to other systems having a mechanism that automates memory management such as the garbage collection.

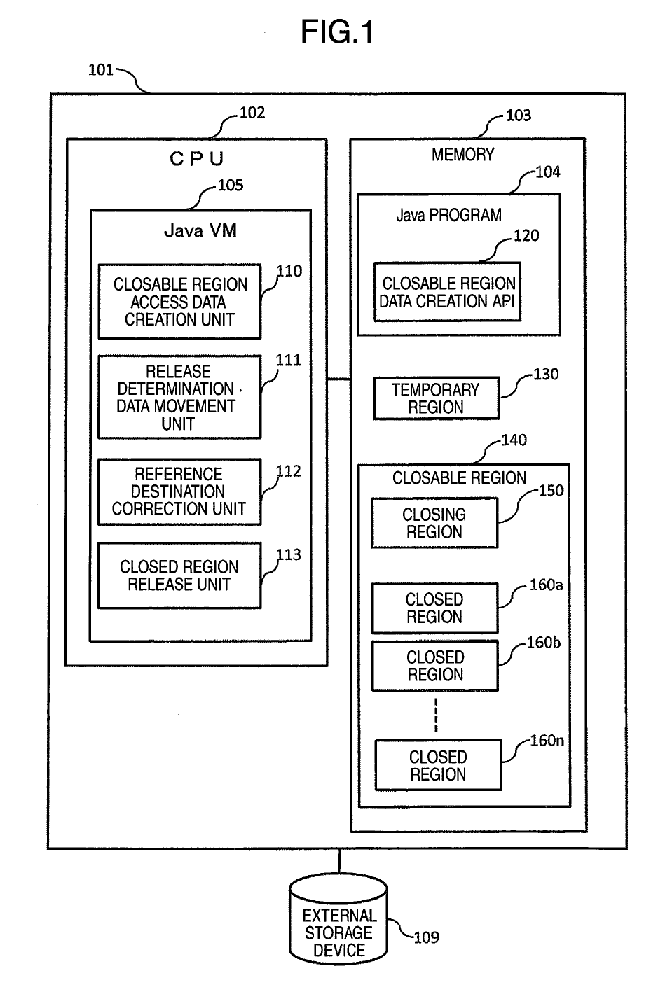

A configuration of a computer system is shown in FIG. 1. The computer system is a server device including a CPU 102, a memory 103 functioning as a main storage device, an external storage device 109 functioning as an auxiliary storage device, an input device (not illustrated) which accepts user operation, and a display device (not illustrated) which outputs various kinds of information. By the way, the external storage device 109 may be provided in a computer system 101.

In the computer system, a Java VM (Virtual Machine) 105 is constituted by cooperation with a program and the CPU 102 in order to provide an operation environment for functioning as a Java virtual machine. A Java program 104 is, for example, at least one user application (AP) or the like which can be executed in the Java VM 105. Data (for example, an object) created by execution of the Java program 104 is first retained in a temporary region 130 or a closing region 150 described later in the memory 103.

One of features of the computer system in the present embodiment exists in a configuration of storage regions of data. The temporary region 130 and a closable region 140 are adapted to be provided on the memory 103 in the computer system as data storage regions. The temporary region 130 is a storage region where data created and used by the Java program 104 is temporarily retained. Data created by execution of the Java program 104 is adapted to be retained in the temporary region 130 or the closing region 150. Disposition of data into the closing region is executed by a specific API (Application interface). Data in the temporary region that can be referenced by data disposed in the closing region is also adapted to move into the closing region 150 at the time of garbage collection.

The closable region 140 is a storage region into which data retained in the temporary region 130 can be moved at an arbitrary opportunity. Storage regions of two kinds, i.e., at least one closing region 150 and at least one closed region 160 are provided in the closable region 140.

The closing region 150 is a region that becomes a movement destination of data from the temporary region 130. The closing region 150 is a storage region in which additional storage of new data and overwriting and the like of updated data can be conducted. The closed region 160 is a region that does not become a movement destination of data stored in the temporary region 130 and the closing region 150. The closed region 160 is a storage region where it is impossible to conduct additional storage of new data and make a change such as overwriting on retained data. As for relationships between the closing region 150 and the closed region 160, when a use quantity of the closing region has reached a predetermined quantity, the closing region 150 becomes the closed region 160. In other words, the closed region 160 is a storage region in which it can be ensured that a change does not occur in references to data retained in the temporary region 130 once the closed region 160 becomes closed.

Therefore, there is an effect that it becomes unnecessary to conduct reference investigation on data stored in the closed region 160 at the time of investigation of reference relationships with the temporary region 130 in garbage collection, the reference investigation region can be restricted, and it is possible to shorten stopping time of a thread in the Java program 104 at the time of garbage collection.

By the way, “reference relationships with the temporary region 130 is severed” represents that references are deleted explicitly by program execution or data movement to the closing region 150 is completed as described later. It is possible to determine at the time of garbage collection whether all references to the temporary region 130 have severed actually.

By the way, the closed region 160 is a region where a change cannot be made on data retained in itself and only reference to the data is made possible. In a case where a change is made tentatively, it is made possible to change data by moving data to be changed into the closing region 150. More specifically, the Copy on Write scheme in which the data is copied into the closing region 150 and update processing is conducted on copied data is applied. As a result, it becomes possible to set a data changeable region and a data unchangeable region without exerting influence upon programing conducted by the user.

The Java program 104 includes a closable region access data creation API. The closable region access data creation API specifies a storage destination of data created by the Java program 104, by using various declarations.

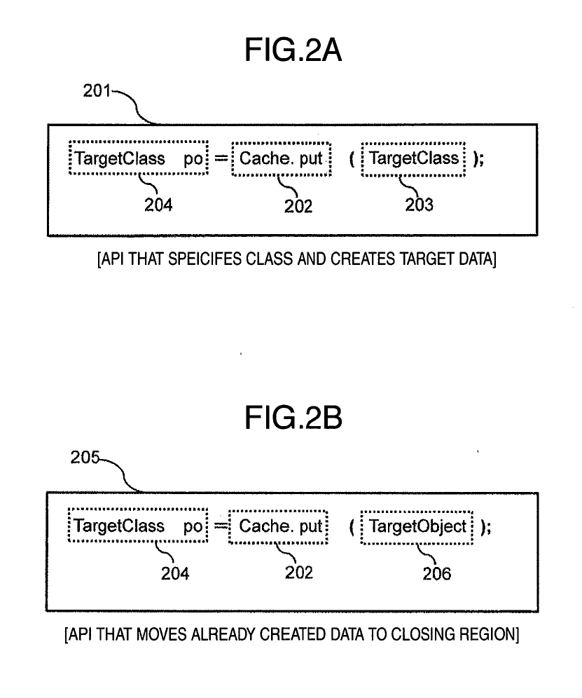

A statement representing a concrete example of the closable region data creation API is shown in FIG. 2A. A statement 201 is an example of API use for creating target data from class information. A put method 202 in a closable region management class “Cache” is called. “TargetClass” is taken in an argument 203 as a class of data to be created (hereafter referred to as “target class” in some cases). Specific data 204 (“TargetClass po”) created in a closable region access data creation unit 110 is returned as a return value. The present specific data 204 looks as if it is a target class similar to the class 203.

A statement 205 shown in FIG. 2B is an API utilization example in which existing data is moved to the closing region 150. In this case, the argument 203 in the put method 202 in the statement 201 becomes existing data 206 (“TargetObject”) in the temporary region 130.

As for disposition of the specific data and the object data on the memory 103, the specific data is created in the temporary region 130, and the target data created on the basis of the target class 203 is created in the closing region 150. The target data is referenced from the specific data. By the way, the specific data and the target data are in one-to-one correspondence. Access to the target data 204 created in the closing region 150 is conducted via the specific data in the temporary region 130.

By the way, in the case of the statement 205, existing data in the temporary region 130 is moved into the closing region 150, and a similar referencing form is taken.

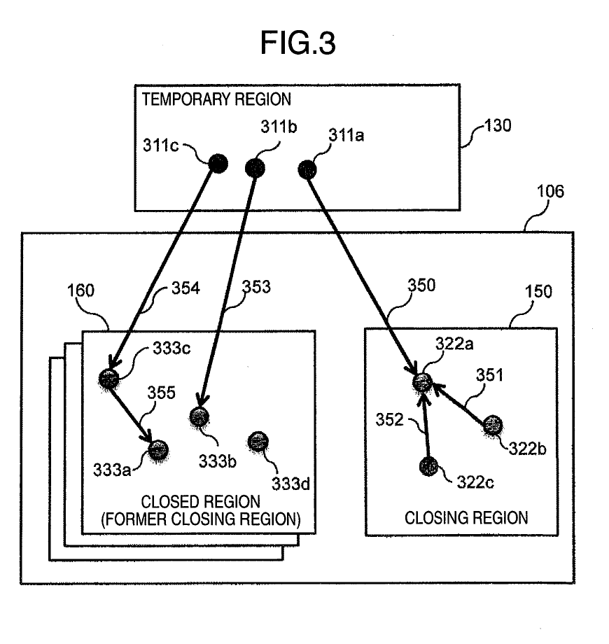

Respective storage regions in the memory 103 described heretofore, data disposition, and reference relationships are schematically shown in FIG. 3. Specific data 311a, 311b and 311c are disposed in the temporary region 130. Target data 322a, 322b and 322c are disposed in the closing region 150. Target data 333a, 333b 333c and 333d are disposed in the closed region 160.

The specific data 311a references the target data 322a in the closing region 150 by a reference 350. The target data 322b and 322c also reference the target data 322a by references 351 and 352, respectively.

The specific data 311b or 311c references the target data 333b or 333c by a reference 353 or 354 in the closed region 160, respectively. The target data 333a in the closed region 160 is referenced from the target data 333c in the same closed region 160 by a reference 355. The target data 333d is not in reference relationship with any data.

Referring back to FIG. 1, a configuration of the Java VM 105 will now be described.

The Java VM 105 includes, as functional units thereof, a closable region access data creation unit 110, a release determination•data movement unit 111, and a closed region release unit 113.

The closable region access data creation unit 110 is a functional unit that creates specific data 311 (a to c) which points to target data retained in the closing region 150 and the closed region 160. In a case where the Java program 104 accesses the target data 322a in the closing region 150 or the target data 333b and 333c in the closed region 160, the Java program 104 is adapted to access them via the specific data 311a to 311c, respectively.

The release determination•data movement unit 111 is a functional unit that selects a storage region that is the release object from the closed region 160 in the closable region 140 and bears a part of “closed region release processing.” Specifically, the release determination•data movement unit 111 is adapted to select a closed region 160 that is the release object on the basis of various selection criteria such as, for example, excess of the region use quantity over a preset threshold, every predetermined time, or after end of predetermined processing in the Java program 104. And in a case where there is a direct or indirect reference relationship to data stored in the closed region 160 selected as the release object, from data in all regions other than the region that is the release object, the release determination•data movement unit 111 is adapted to move (for example, copy) the data stored in the closed region 160 selected as the release object, into the closing region 150.

In a case where data that had a reference relationship with specific data retained in the temporary region 113 before being moved into the closing region 150 by the release determination•data movement unit 111 is accessed by the Java program 104 after being moved into the closing region 150, the reference destination correction unit 112 which is a functional unit changes references to the data after being moved. The present functional unit is executed in parallel with the “closed region release processing” as one of features thereof.

The closed region release unit 113 is a functional unit that executes release of a storage region in response to that there is no reference to data retained in the closed region 160 selected as the release object, from data retained in a region other than the release object.

As one of features in the present embodiment, it can be mentioned that processing conducted by the release determination•data movement unit 111, the reference destination correction unit 112, and the closed region release unit 113 is executed in parallel with ordinary processing conducted by the Java application 104. Formerly, for releasing a storage region, it was necessary to temporarily stop the processing of the Java program 104 in order to avoid occurrence of a change on data stored in the object storage region during the release processing. On the other hand, in the present embodiment, the reference relationship investigation required for release processing and the release processing can be executed in parallel with ordinary processing of the Java program 104. Therefore, there is an effect that the stopping time of the Java application 104 can be reduced.

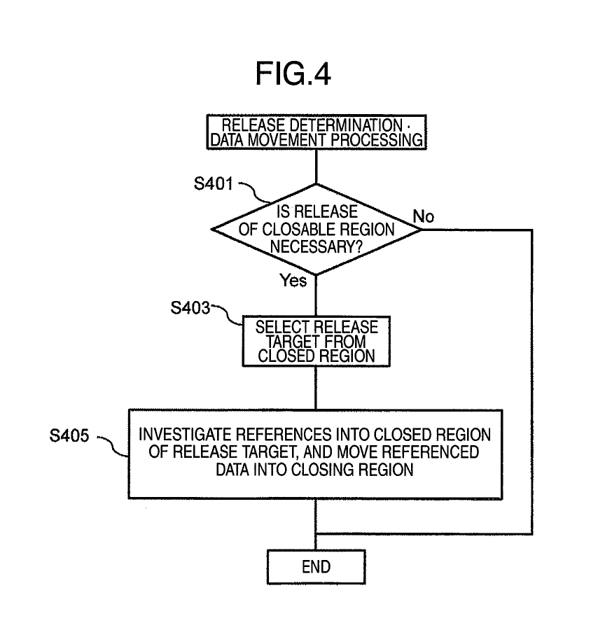

Processing in the computer system 101 having the configuration described heretofore will now be described with reference to flow diagrams shown in FIGS. 4 to 6.

FIG. 4 shows a flow of “release determination•data movement processing” conducted by the release determination•data movement unit 111.

At S401, the release determination•data movement unit 111 determines whether release of the closable region 140 is necessary. As for the determination criterion, for example, excess of the memory use quantity over a preset threshold, every predetermined time, or after end of certain processing in the Java program 104 is conceivable.

In a case where release is determined to be necessary (S401: Yes), the release determination•data movement unit 111 selects the release object region from the closed region 160 at S403. As for a criterion of this selection, for example, an order of increasing frequency of access to a series of closed regions 160, an order of increasing time from creation, or a method of selecting regions where data known to be not utilized after end of certain processing in the Java program 104 is disposed, until a desired release quantity is reached, is conceivable.

At S405, the release determination•data movement unit 111 investigates references to the closed region 160 selected as the release object from all regions other than the release object, moves all data that can be referenced directly or indirectly into the closing region 150, and finishes the processing.

By the way, during execution of the series of release processing as well, predetermined processing in the Java program 104 continues to operate in parallel. If there is a reference to data in the closed region 160 that is the release object from data in a region (for example, the temporary region 130) other than the release object and the data is moved into the closing region 150, therefore, reference from the data in the region other than the release object becomes impossible. To be more detail, when accessing data in the closable region 140 from the Java program 104, it is necessary to access the data via specific data disposed in the temporary region 130 as described earlier. In a case where target data in the closable region 140 seen from the specific data exists in the closed region 160, however, there is a possibility that the target data will be moved into the closing region 150 due to the above-described data movement executed in parallel.

In parallel with the processing of the release determination•data movement unit 111 shown in FIG. 4, therefore, reference correction processing is conducted to keep reference destination from the specific data the latest.

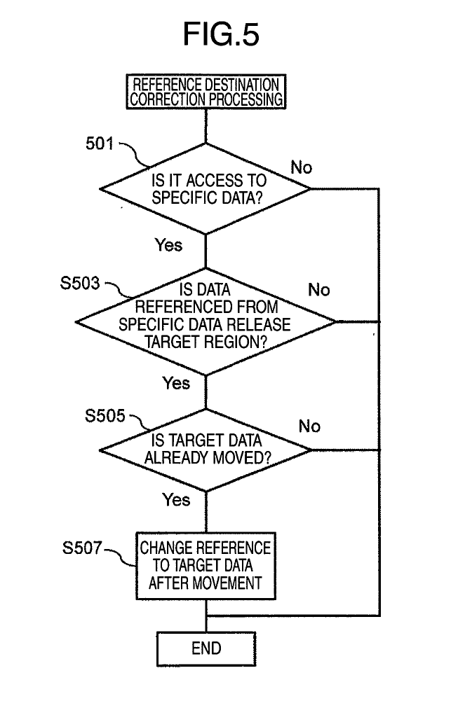

A flow of “reference destination correction processing” conducted by the reference destination correction unit 112 is shown in FIG. 5.

At S501, the reference destination correction unit 112 determines whether data access from the Java program 104 is access made via specific data. In a case where the data access is access made via specific data (S501: Yes), the processing proceeds to S503.

At S503, the reference destination correction unit 112 determines whether target data referenced from specific data is in the closed region 160 that is the release object. In a case where the target data is in the closed region 160 that is the release object (S503: Yes), the processing proceeds to S505.

At S505, the reference destination correction unit 112 determines whether the target data is already moved into the closing region 150. In a case where the target data is already moved into the closing region 150 (S505: Yes), the processing proceeds to S507.

At S507, the reference destination correction unit 112 changes the reference destination from the specific data to the target data after the movement.

The reference correction processing described heretofore is executed in parallel with the release determination•data movement processing. As a result, the ordinary processing of the Java program 104 is prevented from being stopped.

If the reference to the closed region 160 that is the release object is severed as a result of the reference correction processing, the release processing unit 113 executes release processing of the closed region 160.

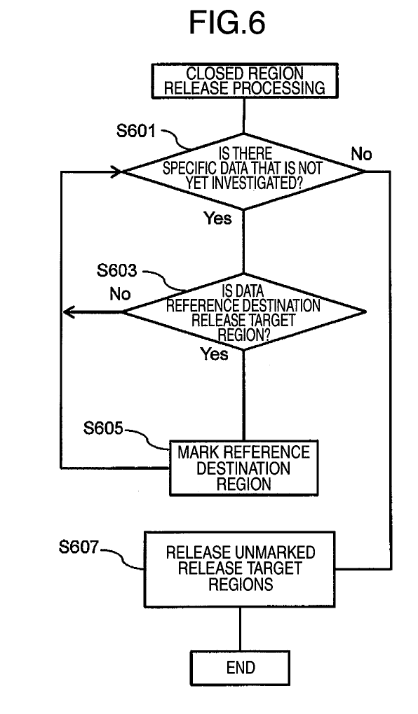

A flow of “closed region release processing” conducted by the closed region release unit 113 is shown in FIG. 6.

At S601, the closed region release unit 113 checks whether there is specific data in the temporary region 130 that is not yet subjected to reference investigation. In a case where there is uninvestigated specific data (S601: Yes), the processing proceeds to S603. In a case where there isn't uninvestigated specific data (S601: No), the processing proceeds to processing at S607.

At S603, the closed region release processing unit 113 selects one uninvestigated specific data, and determines whether data referenced from the specific data is retained in the closed region 160 that is the release object. In a case where a reference to the closed region 160 that is the release object is retained (S603: Yes), the closed region release unit 113 marks (checks) the closed region 160 and returns to the S601. In a case where referenced data is not retained in the closed region 160 (S603: No), the processing returns to S601.

After this processing is executed on all specific data (S601: No), the unmarked closed regions 160 are released at S605 and the processing is finished.

In the unmarked closed region 160, there is no data reference at all to data retained in the region from data retained outside the region. This ensures that data required for execution of the Java program 104 does not exist. Therefore, this means that release of the entire region does not exert any influence upon ordinary execution of the Java program 104.

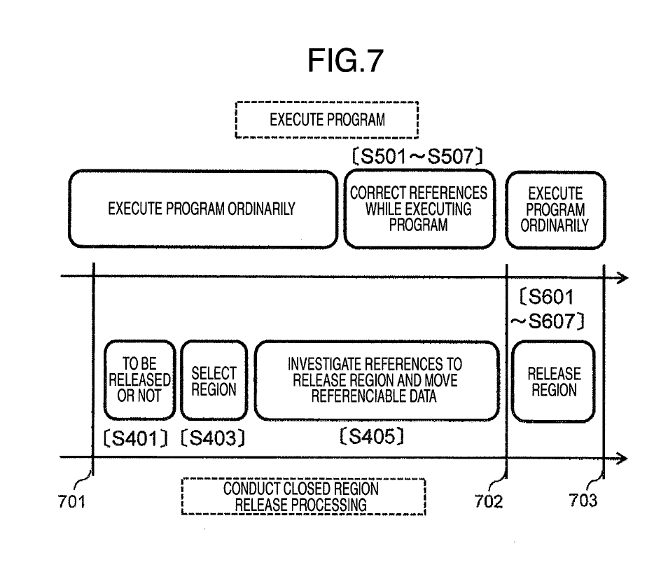

The processing described heretofore with reference to FIGS. 4 to 6 is summarized by using a schematic diagram. A flow of a series of processing at the time when releasing the closed region 160 is schematically shown in FIG. 7. FIG. 7 shows from the left to the right how the ordinary processing of the Java program 104, the specific data reference correction processing, the release determination•data movement processing, and release processing of the closed region 160 are executed in time series.

At time 701, the “release determination•data movement processing (FIG. 4)” is executed in parallel with the Java program 104. Specifically, the release determination•data movement processing unit 111 determines whether it is necessary to release the closable region 140 (S401), selects a closed region 160 that becomes a release object (S403), and conducts investigation of references to data retained in the selected release object region from data retained in a region other than the release object and processing of moving referenced data into the closing region 150 (S405).

The “reference destination correction processing” of specific data is executed in parallel with the “release determination•data movement processing.” Specifically, it is determined whether data access from the Java program 104 is access made via specific data (S501). In a case where the data access is access made via specific data, it is determined whether target data is retained in the closed region 160 that is the release object (S503). In a case where the target data is retained in the release object region, it is determined whether the target data is already moved into the closing region 150 (S505). In a case where the target data is already moved into the closing region 150, the reference destination from the specific data is changed to the target data after the movement (S507).

At time 702, the closed region release unit 113 executes the “closed region release processing.” In parallel with this, the Java program 104 is brought into a state in which the Java program 104 executes ordinary program execution in parallel.

By the way, the reference destination correction processing from specific data shown in S501 to 507 is executed in keeping with execution of the Java program 104. Depending upon the advance of the program, therefore, it is also expected that specific data that is not accessed will appear. If such specific data exists, it is also considered that the closed region release processing at S601 to 607 stagnates and a situation in which the closed region is not released is brought about. In such a case, it is also possible to stop all threads that execute the Java program 104 for a time at an arbitrary time point after the data movement processing at the S405 is finished and forcibly execute the reference destination correction processing from specific data.

Furthermore, as another configuration, only a thread having specific data that retains a reference to the release object region may be stopped by managing specific data for a thread group that executes the Java program, as thread local data. In this case, an effect that it is not necessary to stop all threads even when forcibly executing the reference destination correction processing from specific data is obtained.

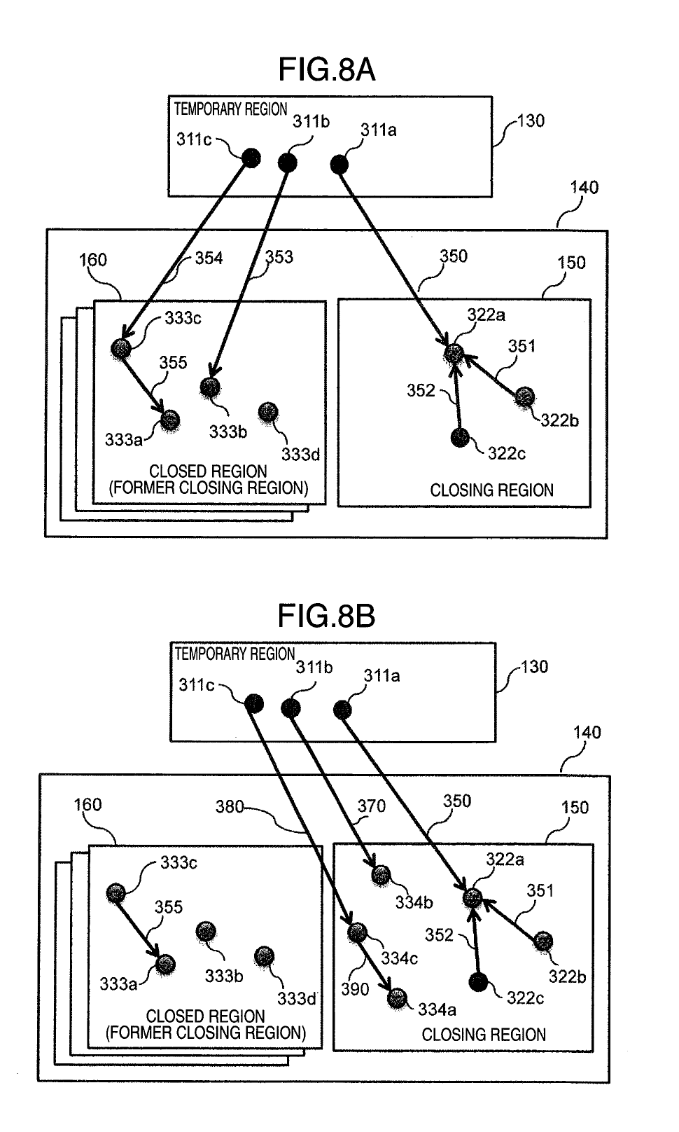

Finally, relationships between data storage regions and references at time points of the time 701 (before the release processing) and time 702 (immediately before the release of the closed region 160) will be described. A memory image at the time 701 is shown in FIG. 8A. A memory image at the time 702 is shown in FIG. 8B.

In FIG. 8A, specific data 311a, 311b and 311c are disposed in the temporary region 130. Target data respectively corresponding to them are 322a, 333b and 333c.

Among data retained in the closed region 160, 333b and 333c are referenced directly from the specific data 311b and 311 by a reference 353 and a reference 354, respectively. Data 333a is referenced indirectly.

As shown in FIG. 8B, therefore, the data 333b, 333c and 333a are moved (copied) into the closing region 150 and become data 334b, 334c and 334a, respectively.

In the reference destination correction processing, the references 353, 354 and 355 are also newly changed to references 370, 380 and 390, respectively. Thereafter, the closed region 160 is released.

One of features of the present embodiment is that while making it possible to reference data required for ordinary execution of the Java program 104, i.e., data having reference relationships, it is possible to allocate a region retaining only data having reference relationships, it is possible to allocate a region retaining only data having no such references (for example, a closed region 160 of release object) in storage areas. Owing to this configuration, there is an effect that the range of reference investigation can be restricted and the time required for the reference investigation can be reduced.

Furthermore, another one of features of the present embodiment is that data having a reference relationship are collected into a specific storage region (for example, the closing region 150) and in a case where there is access to data in the movement from the Java program 104, reference destination correction processing on the data is executed in parallel. As a result, there is an effect that it becomes unnecessary to provide processing time for reference correction separately and it becomes unnecessary to stop the ordinary execution of the Java program 104.

By the way, the present invention is not restricted to the above-described various configurations. Without changing the spirit of the present invention, various configurations that will occur to those skilled in the art can be applied. In particular, in the present embodiment, an example in which respective functional units are constituted by cooperation with a program has been described. However, it is also possible to make a part of them hardware processing.

In addition, as for various programs described in the present embodiment, a part or the whole can be stored in an electronic•electromagnetic and/or an optical recording medium and install on a computer, or can be downloaded via a wired or wireless communication network such as Internet.

### REFERENCE SIGNS LIST

101: Computer system
104: Java program
105: Java VM
110: Closable region access data creation unit
111: Release determination•data movement unit
112: Reference destination correction unit
113: Closed region release unit
130: Temporary region
140: Closable region
150: Closing region
160: Closed region

1. A computer comprising first and second storage regions that make it possible to change data retained therein, a third storage region that makes it impossible to change data retained therein, and a control unit that executes access to data retained in the second and third storage regions in response to a request from a program, wherein
the control unit creates specific data for accessing data retained in the second and third storage regions, in the first storage region;
the control unit causes the specific data to include reference information to data retained in the third storage region;
in a case where while executing processing of moving data having a reference relationship with the specific data among data retained in the third storage region that is a release object into the second storage region, access to data retained in the third storage region via specific data occurs from the program, the control unit determines whether data that is an access object is already moved into the second storage region;
in a case where data that is an access object is already moved into the second storage region, the control unit corrects reference information contained in the specific data to data of a movement destination, accesses the data that is an access object, and corrects all references from specific data having a reference relationship with data retained in the third storage region; and
after the control unit corrects all of the references, the control unit releases the third storage region.

2. The computer according to claim 1, wherein the control unit executes movement of data retained in the third storage region having a reference relationship with the specific data into the second storage region and correction of references to the data to which access has occurred in parallel with ordinary processing of the program.

3. The computer according to claim 1, wherein
in a case where the third storage region is released before all references of the specific data having a reference relationship with data retained in the third storage region are corrected, the control unit stops access to data retained in the third storage region from the program, and
the control unit corrects references from specific data having a reference relationship with data retained in the third storage region.

4. The computer according to claim 3, wherein the control unit regards specific data as thread local data, stops only data operation processing in a thread that handles the thread local data, and corrects the references.

5. The computer according to claim 1, wherein
the control unit executes investigation of references to data retained in the third storage region having a reference relationship with the specific data and movement of the data having a reference relationship detected by the investigation into the second storage region by using a program that has issued a request to access to the data, and
after moving all of the data having the reference relationship into the second storage region, the control unit releases the third storage region.

6. A program that causes a computer including first and second storage regions that make it possible to change data retained therein, a third storage region that makes it impossible to change data retained therein, and a control unit that executes access to data retained in the second and third storage regions in response to a request from the program to execute:
a procedure for setting specific data for accessing data retained in the second and third storage regions, in the first storage region;
a procedure for causing the specific data to include reference information to data retained in the third storage region;
a procedure for moving data having a reference relationship with the specific data among data retained in the third storage region that is a release object into the second storage region;
a procedure, in a case where while executing the procedure for moving, access to data retained in the third storage region via specific data occurs from the program, for determining whether data that is an access object is already moved into the second storage region;
a procedure, in a case where data that is an access object is already moved into the second storage region, for correcting reference information contained in the specific data to data of a movement destination, accessing the data that is an access object, and correcting all references from specific data having a reference relationship with data retained in the third storage region; and
a procedure for releasing the third storage region after correcting all of the references.

7. The program according to claim 6, wherein the program causes the computer to execute the procedure for moving data retained in the third storage region having a reference relationship with the specific data into the second storage region and the procedure for correcting references to the data to which access has occurred in parallel with ordinary processing of the program.

8. The program according to claim 6, wherein the program causes the computer to execute:
a procedure for stopping access to data retained in the third storage region from the program, in a case where the third storage region is released before all references of the specific data having a reference relationship with data retained in the third storage region are corrected; and
a procedure for correcting references from specific data having a reference relationship with data retained in the third storage region.

9. The program according to claim 8, wherein the program causes the computer to execute:
a procedure for regarding specific data as thread local data; a procedure for stopping only data operation processing in the program that handles the thread local data; and
a procedure for correcting the references.

10. A memory management method in a computer including first and second storage regions that make it possible to change data retained therein, a third storage region that makes it impossible to change data retained therein, and a control unit that executes access to data retained in the second and third storage regions in response to a request from a program, wherein
the control unit sets specific data for accessing data retained in the second and third storage regions, in the first storage region;
the control unit causes the specific data to include reference information to data retained in the third storage region;
in a case where while executing processing of moving data having a reference relationship with the specific data among data retained in the third storage region that is a release object into the second storage region, access to data retained in the third storage region via specific data occurs from the program, the control unit determines whether data that is an access object is already moved into the second storage region;
in a case where data that is an access object is already moved into the second storage region, the control unit corrects reference information contained in the specific data to data of a movement destination, accesses the data that is an access object, and corrects all references from specific data having a reference relationship with data retained in the third storage region; and
after the control unit corrects all of the references, the control unit releases the third storage region.
